(19) United States
(12) Patent Application Publication
(10) Pub. No.: US 2004/0158544 A1
(43) Pub. Date: Aug. 12, 2004

(54) Weighted decision making systems, methods and computer program products

(76) Inventors: Jeffrey M. Taekman, Chapel Hill, NC (US); Bryan C. Andregg, Durham, NC (US)

Correspondence Address: Mitchell S. Bigel, Myers Bigel Sibley & Sajovec, P.A., P.O. Box 37428, Raleigh, NC, 27627, US

(21) Appl. No.: 10/772,803

(22) Filed: Feb. 5, 2004

Related U.S. Application Data
(60) Provisional application No. 60/445,655, filed on Feb. 6, 2003.

(51) Int. Cl. G06F 17/00; G06N 5/00

(52) U.S. Cl. 706/45

(57) ABSTRACT

Weighted decision making systems, methods and computer program products assist a user to select a choice from multiple choices, by displaying to the user a set of criteria that pertain to the multiple choices, accepting user selection of at least a subset of the criteria, and accepting user input of weights for the criteria that were selected. User input of a numeric rating for the criteria that were selected is also accepted, for each of the multiple choices. A score is calculated for each choice by summing the products of the numeric rating and the weight for the criteria that were selected. At least one of the choices is then displayed based on the scores that were calculated.

### CROSS-REFERENCE TO PROVISIONAL APPLICATION

This application claims the benefit of Provisional Application Serial No. 60/445,655, entitled Weighted Decision Making System, filed Feb. 6, 2003, assigned to the assignee of the present invention, the disclosure of which is hereby incorporated herein by reference in its entirety as if set forth fully herein.

### FIELD OF THE APPLICATION

This invention relates to computer systems, methods and computer program products, and more particularly to computer-based decision making systems, methods and computer program products.

### BACKGROUND OF THE INVENTION

Each of us is faced with numerous decision making opportunities each day. The decision making process is often more subjective than objective. Numerous factors contribute to our final solution. Illogical mental trade-offs are often made to arrive at a final decision. This final decision may or may not be the best selection for the person.

### SUMMARY OF THE INVENTION

Computer-based decision making methods according to some embodiments of the present invention may be used to select a choice from a plurality of choices. A set of criteria that pertain to the plurality of choices is displayed to a user. User selection of at least a subset of the criteria is accepted. User inputs are accepted of weights of the criteria that were selected. User inputs are then accepted of a numeric rating of the criteria that were selected, for each of the plurality of choices. A score is calculated for each choice by summing the products of numeric rating and the weight for the criteria that were selected. Finally, at least one of the choices is displayed based on the scores that were calculated.

In some embodiments, when accepting user input of weights, different interpretations that a selected criterion may have are displayed to the user. User input is then accepted as to a desired interpretation for the selected criterion. In other embodiments, the weights are scaled. In still other embodiments, when the set of criteria are displayed, they are arranged in groups. According to yet other embodiments, the choices may be displayed based on the scores that were calculated, by displaying a ranking of the plurality of choices based on the scores. Finally, in still other embodiments, the selected criteria, weights and/or scores for a plurality of users are analyzed.

It will be understood that embodiments of the invention have been described above primarily with respect to method aspects. However, related systems and computer program products also may be provided according to embodiments of the present invention.

### BRIEF DESCRIPTION OF THE DRAWINGS

FIG. 1 is a flowchart of overall operations that may be performed by weighted decision making systems, methods and computer program products, according to some embodiments of the present invention.

FIG. 2 is a flowchart of operations that may be performed to accept user selection of criteria, weights and interpretations of criteria, according to some embodiments of the present invention, in order to build a database of criteria and weights.

FIG. 3 is a flowchart of operations that may be performed to accept user inputs of ratings for the plurality of choices, to calculate scores and to display and/or analyze the results, according to some embodiments of the present invention.

FIG. 4 is a functional block diagram that illustrates interaction of various functions, according to some embodiments of the present invention.

FIGS. 5-15 are exemplary display screens that may be used in some embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Embodiments according to the present invention may provide a system to help objectify a decision making process. In some embodiments according to the present invention, an end-user may be able to objectively quantify each of the criteria of a decision making process, weight the importance of each factor, and rate each component of each solution to arrive at a final decision. Embodiments according to the present invention may, therefore, allow a comparison of dissimilar criteria (i.e., “apples to oranges”) and would result in a decision that can reflect the strengths and weaknesses of each solution weighted toward the end-user's preferences.

In some embodiments according to the present invention, a web-based decision making tool is used. Some embodiments according to the present invention can allow prospective medical school residents to determine which potential training program most meets their needs. It will be understood that embodiments according to the present invention can be used in other areas outside medicine, such as professional training decision making, professional position matching, purchase decision making, end-user pharmaceutical choice, physician pharmaceutical prescribing, stock comparisons, college application decisions, or the like. Embodiments according to the present invention can be used for other applications as well.

Some embodiments according to the present invention can include: a web server, a database, and a web application. The web server portion can allow execution of the web application by: 1. creating a directory from which the web application can be executed, e.g., a “cgi-bin” directory, 2. installing the web application into the cgi-bin directory, and 3. configuring the web server to allow execution of the web application from the cgi-bin directory.

In some embodiments according to the present invention, the database is an SQL (Structured Query Language) compliant database. Some embodiments according to the present invention use a predetermined table structure, as shown for example, in Table 1. The database can allow data to be stored and queried independent of a user session and web application.

TABLE 1

```
Sequences:
  dataid, data table unique identifier
  critid, criteria table unique identifier
  progid, program table unique identifier
  exid, extremes table unique identifier
Tables:
  users, CompMatrix users {
      uid, random and unique,
      username, login name,
      password, login secret,
      sessionid, see session table: id,
      critid, see critdata table: id,
      exid, see extremes table: id,
      critdisplay, criteria display preference,
      firstname, Christian name,
      lastname, surname,
      email, email address,
      phone, phone number,
      advisor, advisor name,
  }
  data, CompMatrix data {
      id, see dataid sequence,
      uid, see users table: uid,
      program, see program table: code,
      score, program score,
      critid, see critdata table: id,
      progid, see progdata table: id,
      display, matrix display preference,
      sysHide, saved data,
  }
  criteria, selection criteria {
      code, unique identifier,
      name, descriptive unique identifier,
      category, see categories table,
      alpha, start extreme,
      omega, end extreme,
  }
  programs, resident programs {
      code, unique identifier,
      name, descriptive unique identifier,
      city, location,
      state, location,
  }
  critdata, user criteria data {
      id, see critid sequence,
      ( list: codes, see criteria table ),
  }
  progdata, user program data {
      id, see progid sequence,
      ( list: codes, see criteria table ),
  }
  extremes, user extreme data {
      id, see exid sequence,
      ( list: codes, see criteria table [ constraint requires
alpha ] ),
  }
  categories, criteria categories {
      category, name of category,
  }
  session, user session data {
      id, random and unique,
      time, last user action,
  }
  suggest, user suggestions {
      time, time of submittal,
      suggest, suggestion text,
  }
```

In some embodiments according to the present invention, a user logs in and is prompted to select a set of decision criteria. If a criterion has different possible interpretations (e.g., does “distance from family” mean near to the family is more or less desirable) then the user is asked to select the appropriate interpretation for them. The user is asked to weight each of the criteria relative to one another allocating a total of 100 points between all of the criteria. If the weights don't total to 100, then they may be automatically scaled to 100.

In some embodiments according to the present invention, the user selects a program (such as a residency program), and rates each of the previously selected criteria, for example, from zero to ten (ten being best). The product of the weighting and the rating can provide a score for the respective criteria. The scores for each criteria are summed to arrive at a score for the program. The program and program score (along with criteria selected, weights, and ratings) can be presented in a matrix ordered, for example, from best to worst.

An exemplary implementation illustrating embodiments according to the present invention is on the world-wide-web at anesthesia.mc.duke.edu/compmatrix, the entire contents of which are incorporated herein by reference.

In some embodiments according to the present invention, the web application is written in Python, an interpreted, object oriented programming language. Other languages can used. In operation, the user input to the web application can instantiate an object. The instantiated object can have several associated properties, such as methods or actions that the object can take based on the user input, others can be variables, or pre-assigned values set in the object.

In some embodiments according to the present invention, the object instantiation can: 1. create object properties, such as variables and/or methods, 2. open a connection to the database, and 3. import user input data. The instantiated object can have a number of variables from the user input, either directly of through hidden fields. The web application can use the value of a “target” field to determine what method to call.

In some embodiments according to the present invention, if the target of the object is “Login” or “New Account” the object verifies that both the username and the password field are filled in and that the username doesn't contain any characters other than “A-Za-zO-9.-_”. If either of these checks fails then the object returns an explanation of the problem and redraws the login form. If the target is “Login” then the object calls a method to verify the username against the password and on success updates the session table and marks the user as authenticated; on failure the object returns an explanation and redraws the login form. If the target is “New Account” then the object checks the username for uniqueness and confirms the password. Success updates the session table and marks the user as authenticated; failure returns an explanation and redraws the login form. Once the user has been marked as authenticated every method called first checks this authentication.

Following authentication, new users step through a series of web forms created by the web application. Each of these introduces a “target” that the application then calls the method for. These methods in turn either return success, update the appropriate tables in the database, and call a method to draw the next form, or return a failure and redraw the current form. Once the forms have been filled in correctly the application can display a matrix of programs and scores. In some embodiments according to the present invention, users who have previously setup an account can have their matrix displayed when they log in for subsequently sessions.

In some embodiments according to the present invention, the matrix screen is a web form, which can allow for modification of program scores, selecting new criteria, changing the criteria weights, and rating new programs. Each of these can be called by the object instantiated when a form is submitted. Information stored in the database may be aggregated and analyzed to understand the needs and interests of the user pool as well as to compare and contrast each of the possible solutions.

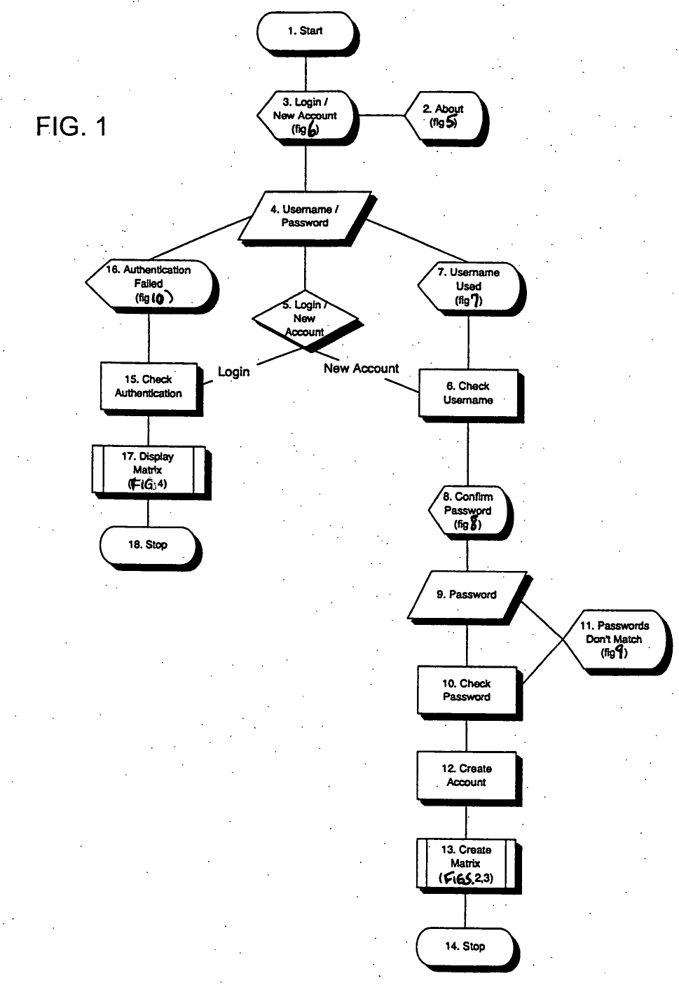

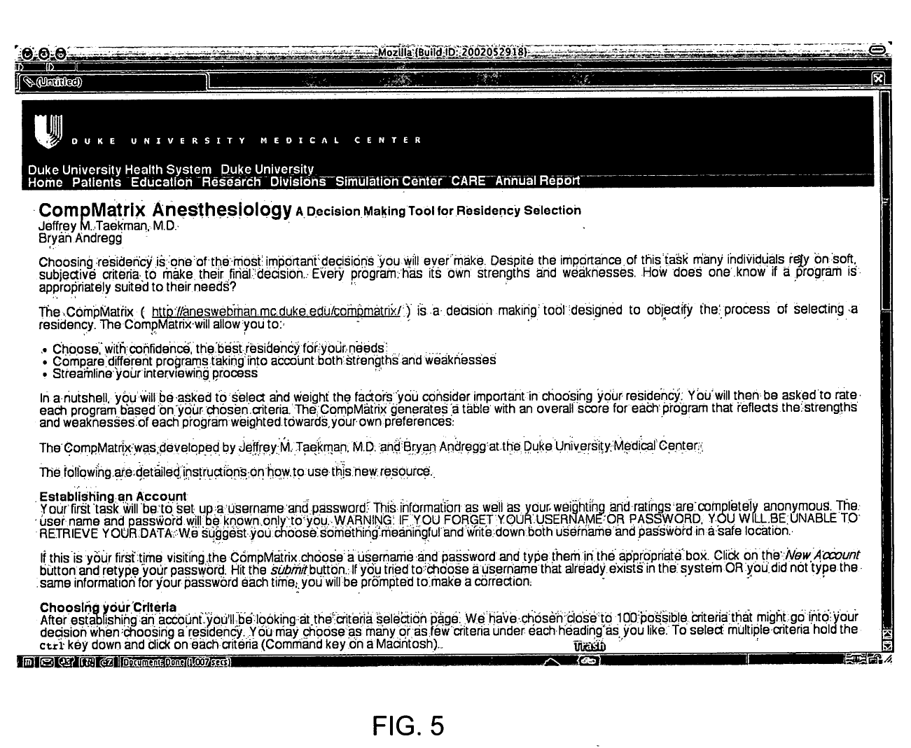

Operations of embodiments according to the present invention, will be further described below in reference to the flowcharts of FIGS. 1-4 and the display screens of FIGS. 5-15. Referring to the numbered blocks in FIG. 1, operations may be initiated as follows:

1. Start: User begins the application.

2. About: The user can choose to view a screen describing the program and how to use it (see FIG. 5).

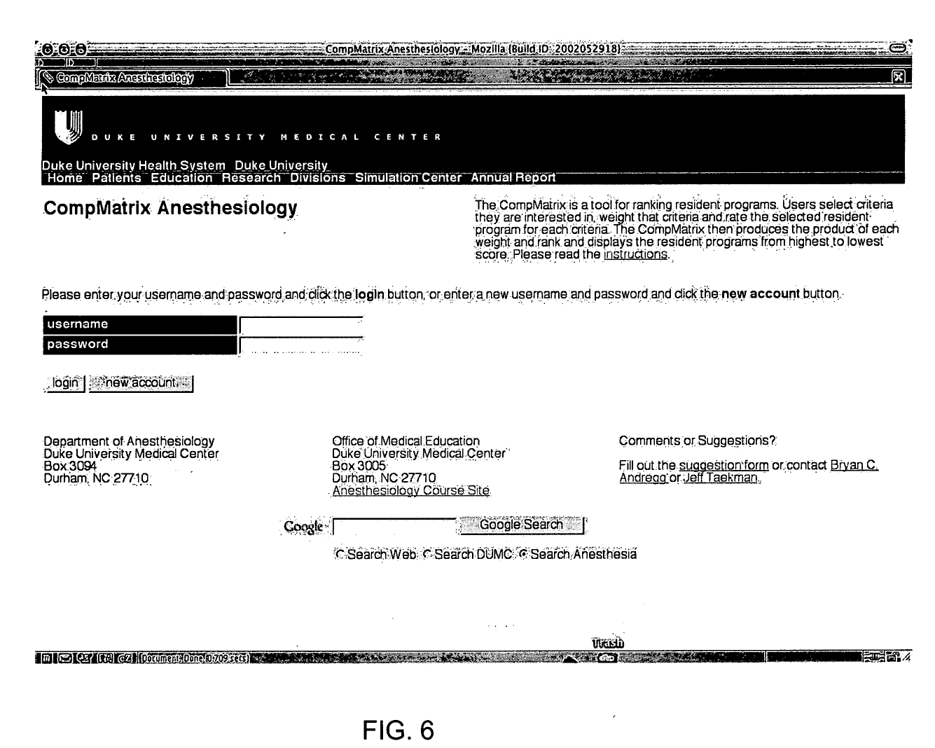

3. Login/New Account: The user is presented with a screen that asks for username and password. After providing the information the user will then select either “login” or “new account” (see FIG. 6).

4. Username/Password: The user inputs a username and password.

5. Login/New Account: The user chooses either “login” or “new account.”

6. Check Username: The application checks the user table in the database to see if this username is already in use.

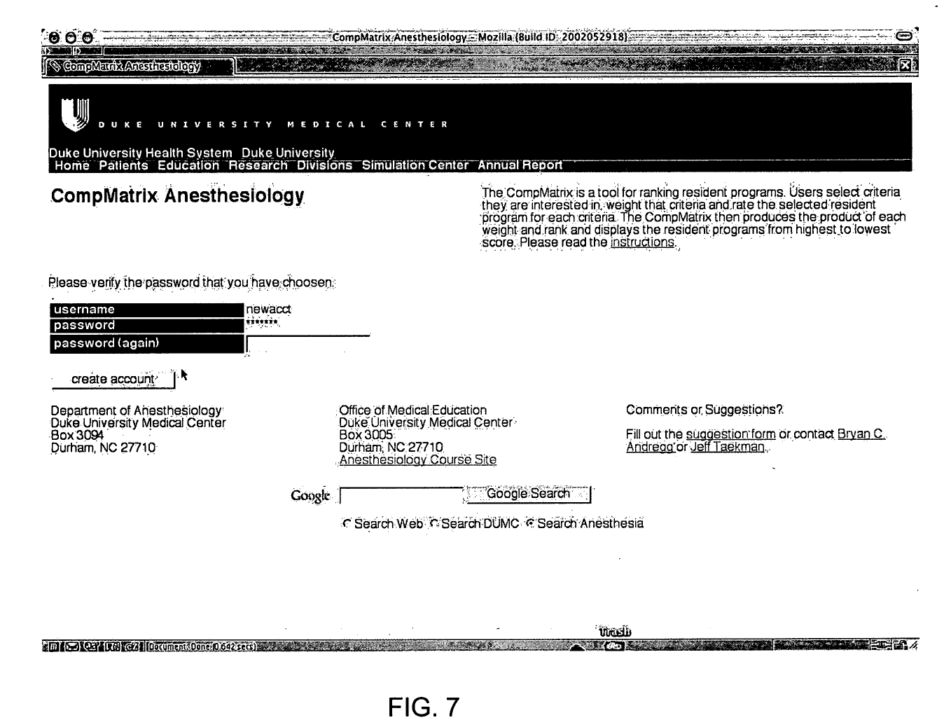

7. Username Used: The username is in use and the user is asked for a username and password again (see FIG. 7).

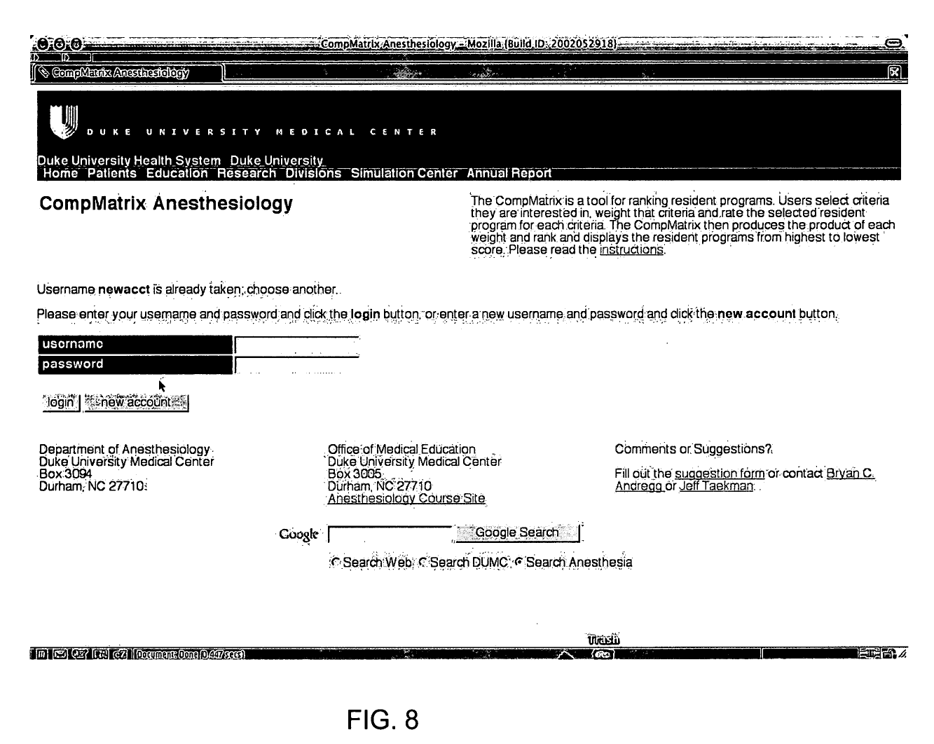

8. Confirm Password: The username was not in use so the user is asked to confirm their password (see FIG. 8).

9. Password: The user inputs the password.

10. Check Password; The application compares the password strings to verify that they are the same.

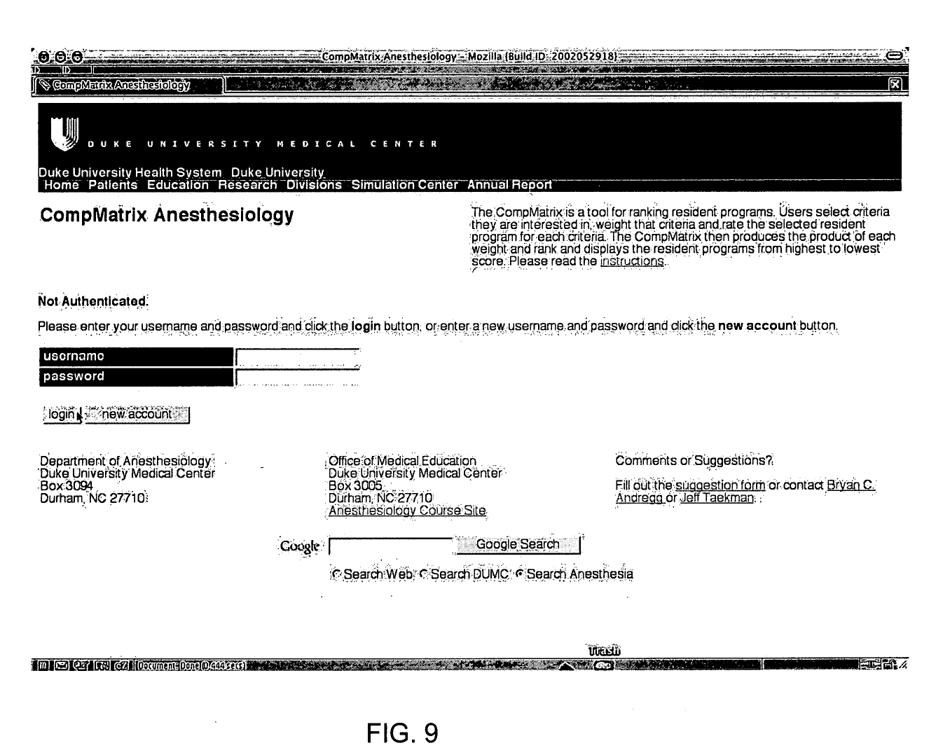

11. Passwords Don't Match: The password strings don't match so the user is asked for a password and a confirmation password (see FIG. 9).

12. Create Account: The application inserts the account details into the database user table.

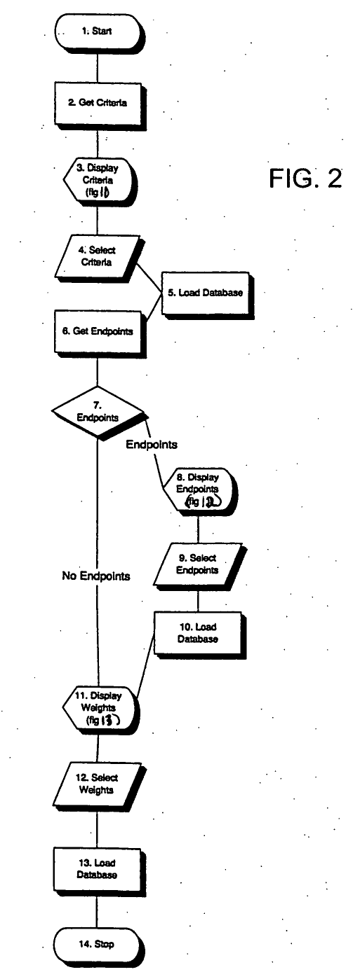

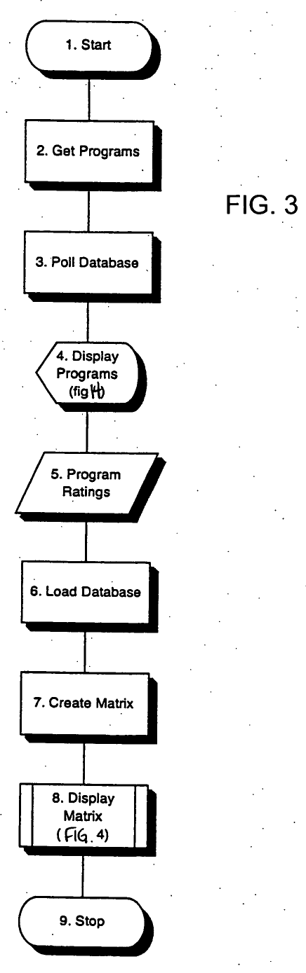

13. Begin CompMatrix: (see FIGS. 2 and 3).

14. Stop.

15. Check Authentication: The application verifies the username from the database user table, encrypts the provided password string, and compares that with the stored password from the database user table.

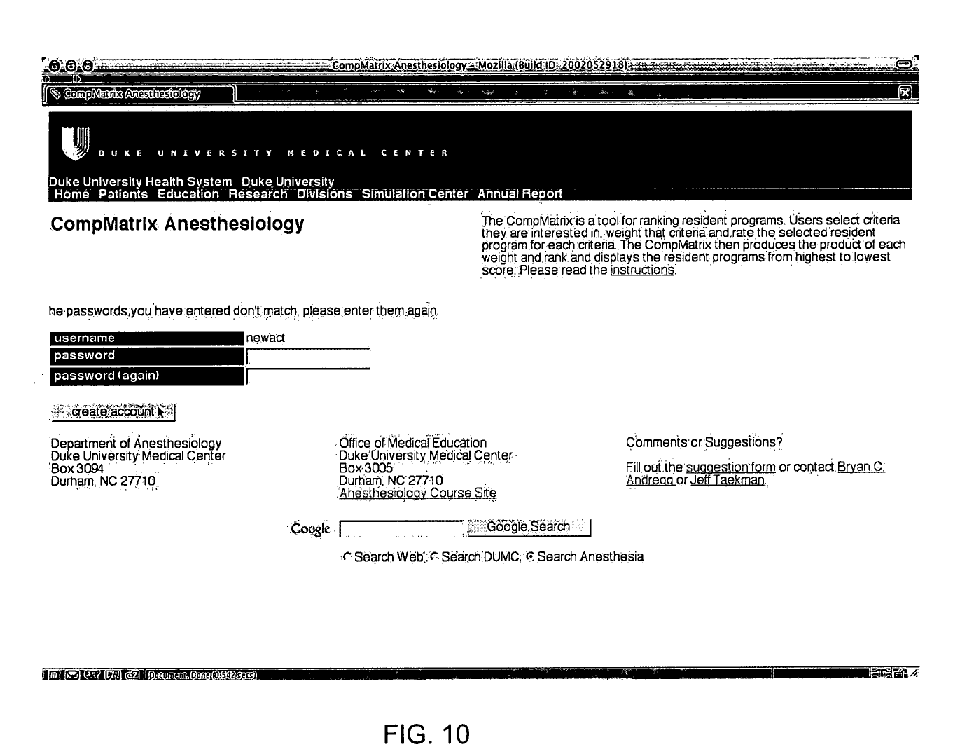

16. Authentication Failed: Either the username didn't exist or the password was incorrect so the user is asked for a username and password (see FIG. 10).

17. Create Matrix: The application selects the user's decision making criteria, weights for that criteria, program ratings for that criteria, and program scores from the database. It uses this information to create a Matrix of program scores.

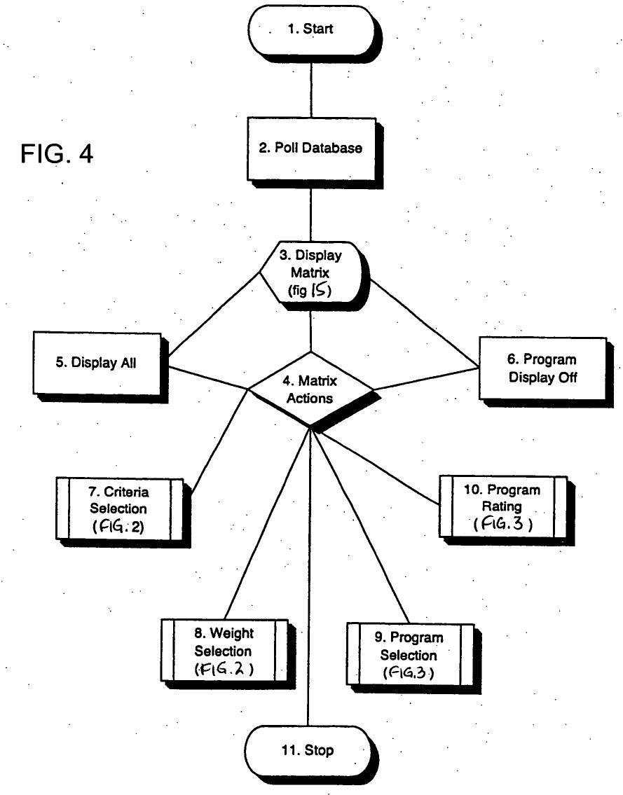

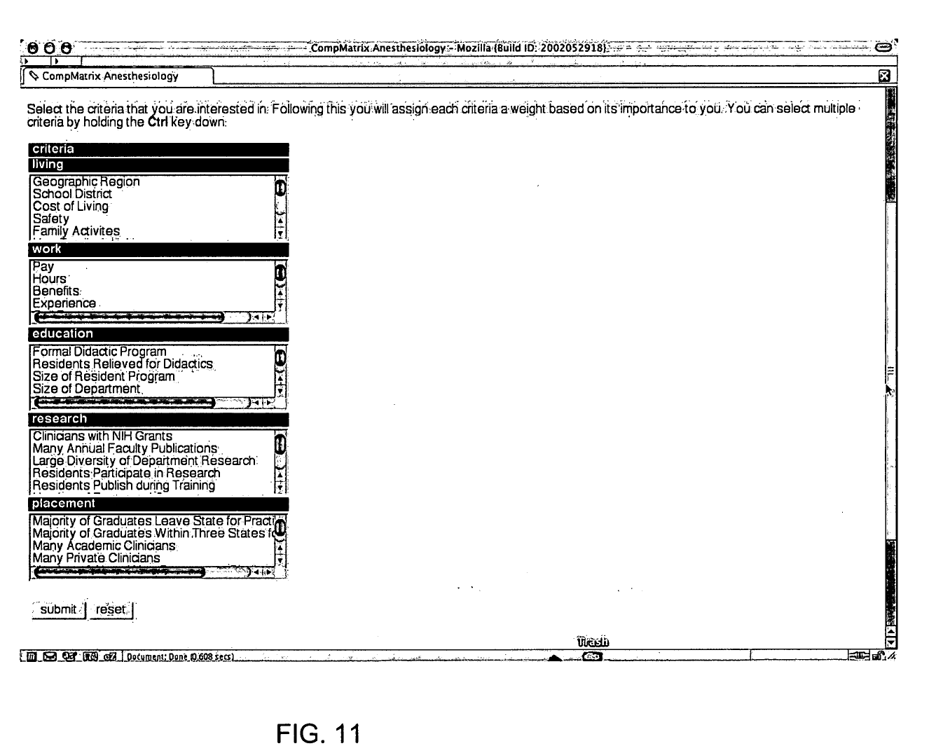

Display Matrix: The application outputs the created display to the user (see FIGS. 4 and 11).

CompMatrix Actions: (see FIG. 4).

18. Stop.

In other embodiments according to the present invention, and referring to the numbered blocks of FIG. 1, operations may begin as follows:

1.1 Start

1.2 Display: About the program (FIG. 5)

1.3 Display: Login or New Account screen (FIG. 6)

1.4 Input: Username and Password

1.5 Decision: Login or New Account

1.6 (New Account) Procedure: Check the database for whether this Username is used already

1.7 (New Account) Display: Username is used; choose another (FIG. 7)

1.8 (New Account) Display: Confirm password for new account (FIG. 8)

1.9 (New Account) Input: Password, again

1.10 (New Account) Procedure: Check if passwords match

1.11 (New Account) Display: Passwords don't match; re-enter passwords (FIG. 9)

1.12 (New Account) Procedure: Create account in database

1.13 (New Account) Extend: Continue the matrix process (FIGS. 2 and 3)

1.14 (New Account) Stop

1.15 (Login) Procedure: Check the database for the username and password

1.16 (Login) Display: Authentication failed; try again (FIG. 10)

1.17 (Login) Extend: Display matrix (FIG. 4, FIG. 11)

1.18 (Login) Stop

Referring to FIG. 2, some embodiments according to the present invention can operate as follows in reference to the numbered blocks of FIG. 2:

2.1 Start

2.2 Procedure: Get criteria from the database

2.3 Display: Select criteria (FIG. 11)

2.4 Input: User selected criteria

2.5 Procedure: Load user criteria into the database

2.6 Procedure: Check database for criteria endpoints

2.7 Decision: If endpoints exist, select them

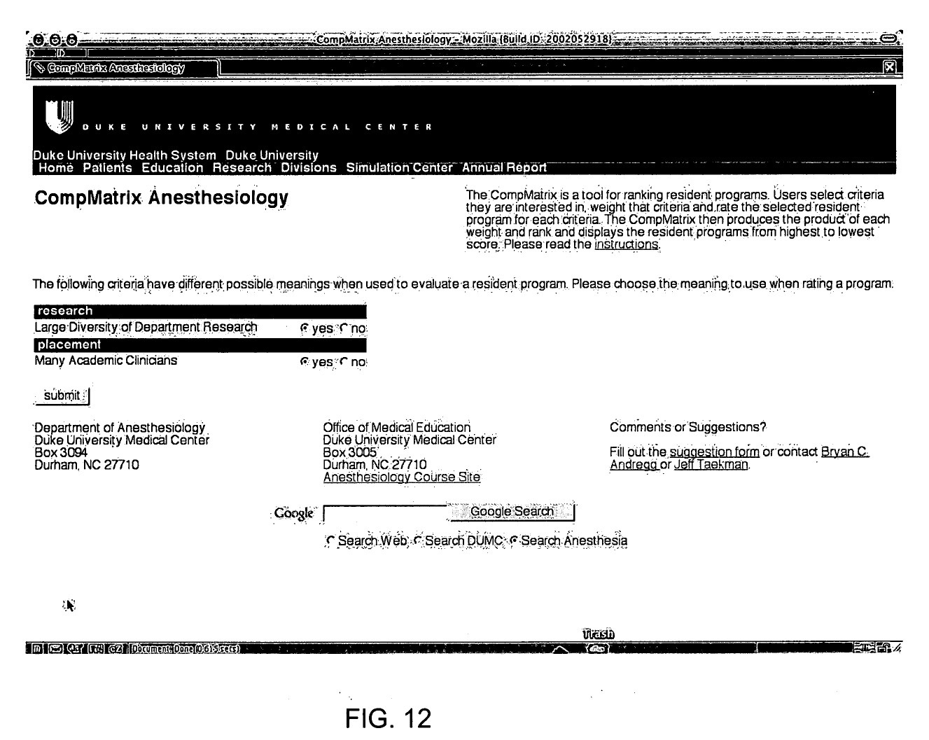

2.8 (Endpoints) Display: Select endpoints (FIG. 12)

2.9 (Endpoints) Input: Select endpoints

2.10 (Endpoints) Procedure: Load endpoints into database

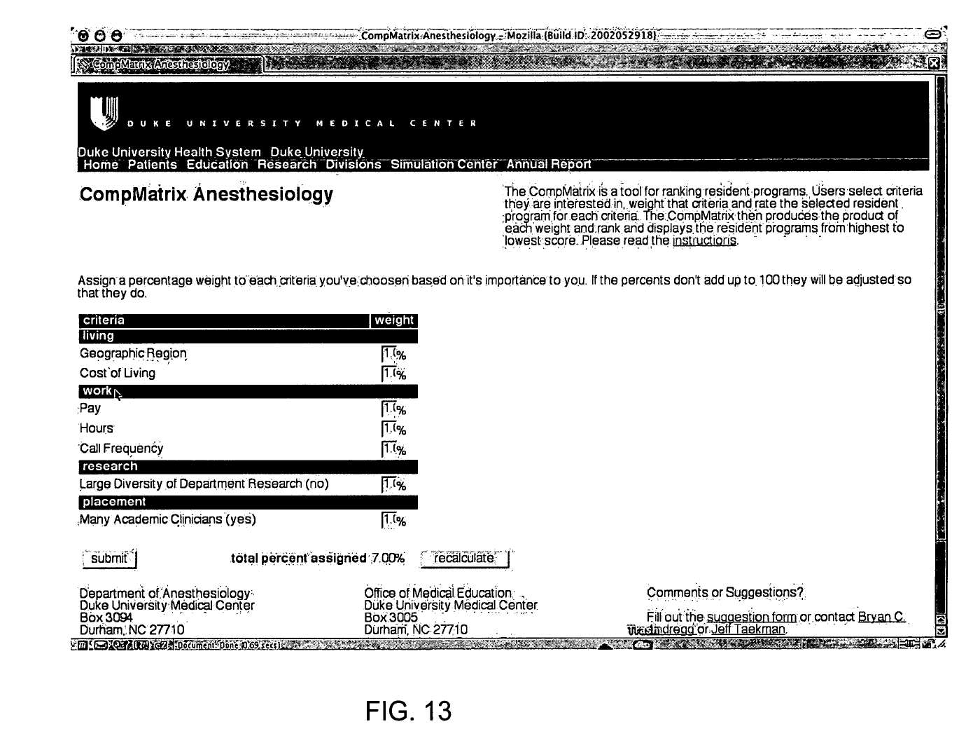

2.11 Display: Select weights for criteria (FIG. 13)

2.12 Input: User weights

2.13 Procedure: Load database with weights for criteria

2.14 Stop

Referring to FIG. 3, some embodiments according to the present invention can operate as follows in reference to the numbered blocks of FIG. 3:

3.1 Start

3.2 Procedure: Get programs from the database

3.3 Procedure: Poll database for user criteria, endpoints, and weights

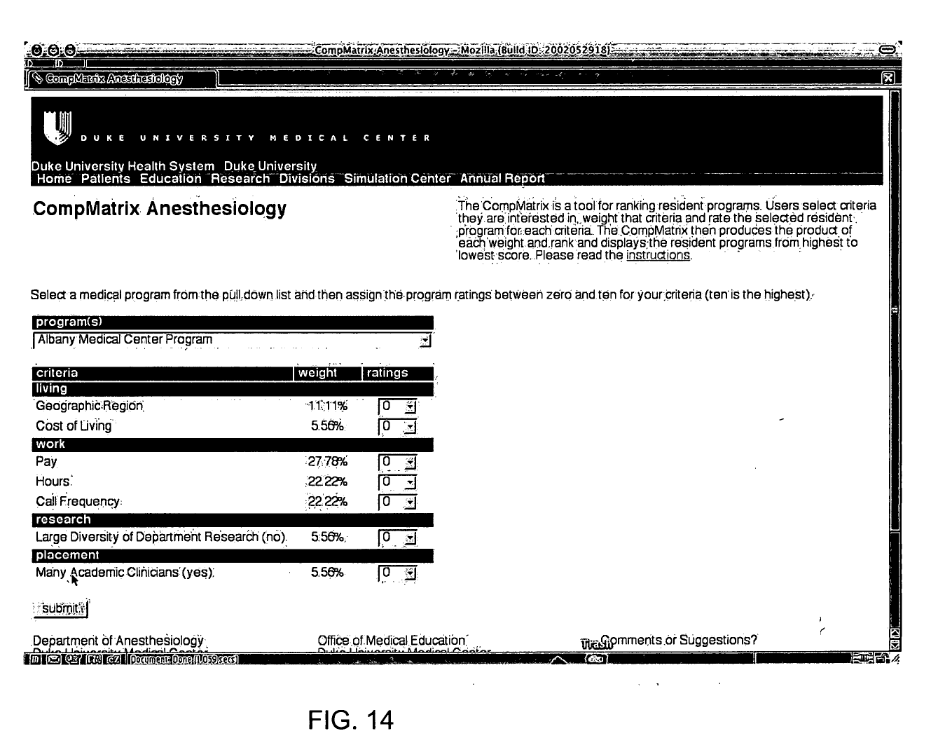

3.4 Display: Display programs and user data (FIG. 14)

3.5 Input: User rating for a program

3.6 Procedure: Load rating into database

3.7 Procedure: Create matrix in database

3.8 Extend: Display Matrix (FIG. 4)

3.9 Stop

Referring to FIG. 4, some embodiments according to the present invention can operate as follows in reference to the numbered blocks of FIG. 4:

4.1 Start

4.2 Procedure: Poll database for matrix

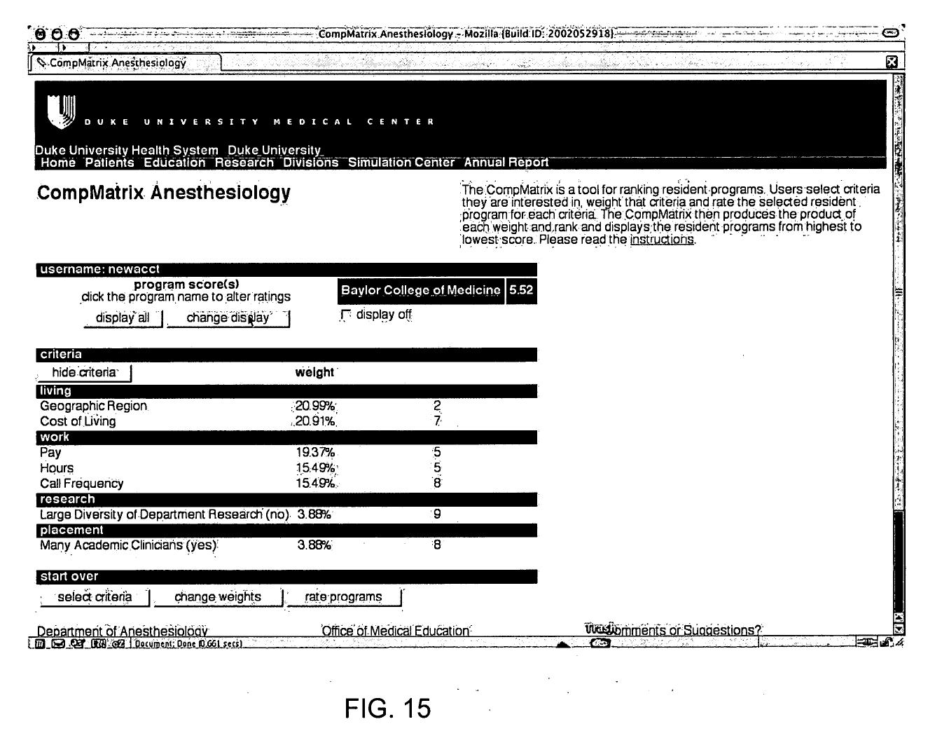

4.3 Display: Display matrix (FIG. 15)

4.4 Decision: Matrix actions

4.5 Procedure: Display all programs and ratings

4.6 Procedure: Turn off display per program

4.7 Extend: Re-select criteria (FIG. 2)

4.8 Extend: Re-weight criteria (FIG. 2, beginning at 11)

4.9 Extend: Rate new program (FIG. 3)

4.10 Extend: Re-rate program (FIG. 3, beginning at 3)

4.11 Stop

Accordingly, some embodiments of the present invention provide computer-based decision making methods, systems and computer program products for selecting a choice from a plurality of choices. A set of criteria that pertain to the plurality of choices is displayed to a user. See, for example, FIG. 2, Block 3; FIG. 4, Block 7 and FIG. 11. A user selection of at least a subset of the criteria is accepted. See, for example, FIG. 2, Block 4; FIG. 4, Block 7 and FIG. 11. User input is accepted of weights for the criteria that were selected. See, for example, FIG. 2, Blocks 11 and 12; FIG. 4, Block 8 and FIG. 13. User input is accepted of a numeric rating for the criteria that were selected for each of the plurality of choices. See, for example, FIG. 3, Blocks 4 and 5; FIG. 4, Blocks 9 and 10, and FIG. 14.

A score is then calculated for each choice by summing the products of the numeric rating and the weight for the criteria that were selected. See, for example, FIG. 3, Block 7 and FIG. 4, Block 4. At least one of the choices is then displayed based on the scores that were calculated. See, for example, FIG. 3, Block 8; FIG. 4, Block 3, and FIG. 15. In other embodiments, in order to accept user input of weights for the criteria that were selected, the user is displayed different interpretations that are selected criterion may have. See, for example, FIG. 2, Blocks 7 and 8, and FIG. 12). User input is then accepted as to a desired interpretation for the selected criterion. See, for example, FIG. 2, Block 9, and FIG. 12. In other embodiments, the weights are scaled. See, for example, FIG. 13. Moreover, as shown, for example, in FIG. 11, the set of criteria may be arranged in groups of criteria. The ranking of the plurality of choices may be displayed based on the scores. The criteria, weights and scores may be analyzed for a plurality of users.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A computer-based decision making method for selecting a choice from a plurality of choices, comprising:
displaying to a user a set of criteria that pertain to the plurality of choices;
accepting user selection of at least a subset of the criteria;
accepting user input of weights for the criteria that were selected;
accepting user input of a numeric rating for the criteria that were selected, for each of the plurality of choices;
calculating a score for each choice by summing the products of the numeric rating and the weight for the criteria that were selected; and
displaying at least one of the choices based on the scores that were calculated.

2. A method according to claim 1 wherein accepting user input of weights for the criteria that were selected comprises:
displaying to the user different interpretations that a selected criterion may have; and
accepting user input as to a desired interpretation for the selected criterion.

3. A method according to claim 1 wherein the following is performed prior to calculating a score for each choice:
scaling the weights.

4. A method according to claim 1 wherein displaying to a user a set of criteria that may pertain to the plurality of choices comprises:
displaying the set of criteria arranged in groups of criteria.

5. A method according to claim 1 wherein displaying at least one of the choices based on the scores that were calculated comprises:
displaying a ranking of the plurality of choices based on the scores.

6. A method according to claim 1 further comprising:
analyzing the criteria that were selected, the weights and/or the scores for a plurality of users.

7. A computer system for selecting a choice from a plurality of choices, comprising:
means for displaying to a user a set of criteria that pertain to the plurality of choices;
means for accepting user selection of at least a subset of the criteria;
means for accepting user input of weights for the criteria that were selected;
means for accepting user input of a numeric rating for the criteria that were selected, for each of the plurality of choices;
means for calculating a score for each choice by summing the products of the numeric rating and the weight for the criteria that were selected; and
means for displaying at least one of the choices based on the scores that were calculated.

8. A system according to claim 7 wherein the means for accepting user input of weights for the criteria that were selected comprises:
means for displaying to the user different interpretations that a selected criterion may have; and
means for accepting user input as to a desired interpretation for the selected criterion.

9. A system according to claim 7 further comprising:
means for scaling the weights.

10. A system according to claim 7 wherein the means for displaying to a user a set of criteria that may pertain to the plurality of choices comprises:
means for displaying the set of criteria arranged in groups of criteria.

11. A system according to claim 7 wherein the means for displaying at least one of the choices based on the scores that were calculated comprises:
means for displaying a ranking of the plurality of choices based on the scores.

12. A system according to claim 7 further comprising:
means for analyzing the criteria that were selected, the weights and/or the scores for a plurality of users.

13. A decision making computer program product that is configured to select a choice from a plurality of choices, the computer program product comprising a computer usable storage medium having computer-readable program code embodied in the medium, the computer-readable program code comprising:
computer-readable program code that is configured to display to a user a set of criteria that pertain to the plurality of choices;
computer-readable program code that is configured to accept user selection of at least a subset of the criteria;
computer-readable program code that is configured to accept user input of weights for the criteria that were selected;
computer-readable program code that is configured to accept user input of a numeric rating for the criteria that were selected, for each of the plurality of choices;
computer-readable program code that is configured to calculate a score for each choice by summing the products of the numeric rating and the weight for the criteria that were selected; and
computer-readable program code that is configured to display at least one of the choices based on the scores that were calculated.

14. A computer program product according to claim 13 wherein the computer-readable program code that is configured to accept user input of weights for the criteria that were selected comprises:
computer-readable program code that is configured to display to the user different interpretations that a selected criterion may have; and
computer-readable program code that is configured to accept user input as to a desired interpretation for the selected criterion.

15. A computer program product according to claim 13 further comprising:
computer-readable program code that is configured to scale the weights.

16. A computer program product according to claim 13 wherein the computer-readable program code that is configured to display to a user a set of criteria that may pertain to the plurality of choices comprises:
computer-readable program code that is configured to display the set of criteria arranged in groups of criteria.

17. A computer program product according to claim 13 wherein the computer-readable program code that is configured to display at least one of the choices based on the scores that were calculated comprises:
computer-readable program code that is configured to display a ranking of the plurality of choices based on the scores.

18. A computer program product according to claim 13 further comprising:
computer-readable program code that is configured to analyze the criteria that were selected, the weights and/or the scores for a plurality of users.
